(19) United States
(12) Patent Application Publication
(10) Pub. No.: US 2007/0188689 A1
(43) Pub. Date: Aug. 16, 2007

(54) ELECTRO-OPTICAL DEVICE, PANEL FOR ELECTRO-OPTICAL DEVICE, METHOD OF MANUFACTURING ELECTRO-OPTICAL DEVICE, AND ELECTRONIC APPARATUS

(75) Inventor: Teiichiro Nakamura, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/672,726

(22) Filed: Feb. 8, 2007

(30) Foreign Application Priority Data
Feb. 10, 2006 (JP) 2006-033341

(51) Int. Cl. G02F 1/1333

(52) U.S. Cl. 349/122

(57) ABSTRACT

An electro-optical device is provided. An embodiment includes a substrate, a plurality of transparent electrodes disposed above the substrate and made of a transparent conductive film, and an optical thin film disposed between the substrate and the transparent electrodes, the refractive index of the optical thin film being at an intermediate level between a refractive index of the substrate and a refractive index of the transparent electrodes, and the thickness of the optical thin film being in a range of from about 55 to about 100 nm.

### CROSS-REFERENCE TO RELATED APPLICATION

The present application claims priority to Japanese Patent Application No. 2006-033341 filed Feb. 10, 2006, which is hereby expressly incorporated by reference herein in its entirety.

### BACKGROUND

1. Technical Field

The present invention relates to a panel for an electro-optical device such as a liquid crystal device, an electro-optical device having the panel, a method of manufacturing the electro-optical device, and an electronic apparatus such as a projector having the elect-o-optical device.

2. Related Art

In a liquid crystal device serving as an example of an electro-optical device, liquid crystal is sealed between a pair of transparent substrates. Transparent pixel electrodes made of an ITO (Indium Tin Oxide) film are arranged in a matrix, for example, on one of the transparent substrates, and counter electrodes made of an ITO film are arranged on the other of the transparent substrates to face the pixel electrodes. When a voltage corresponding to an image signal is applied to a liquid crystal layer disposed between the pixel electrode and the counter electrode, the orientation state of liquid crystal molecules is changed and transmittance of light varies from pixel to pixel. In this way, the transmittance of light passing through the liquid crystal layer varies in accordance with the image signal, thereby enabling images to be displayed.

When displaying images, since incident light passes through the pixel electrode and the counter electrode, in addition to the liquid crystal layer, it is desirable to increase the transmittance of the pixel electrode and the counter electrode in order to realize a high quality image display. For example, JP-A-2005-140836 discloses a technology in which a heterogeneous film is stacked on the ITO film constituting the pixel electrode and the counter electrode to improve the transmittance characteristics of the ITO film.

However according to the technology disclosed in JP-A-2005-140836, it is difficult to effectively improve the transmittance characteristics of the ITO film by simply using an appropriate combination of the refractive index and the thickness of the heterogeneous film stacked on the ITO film.

### SUMMARY

Some embodiments include an electro-optical device, a panel for the electro-optical device, a method of manufacturing the electro-optical device, and an electronic apparatus having the electro-optical device, capable of effectively improving transmittance characteristics thereof and displaying a high quality image.

According to a first embodiment of an electro-optical device, there is provided an electro-optical device including a substrate; a plurality of transparent electrodes disposed above the substrate and made of a transparent conductive film; and an optical thin film disposed between the substrate and the transparent electrodes, a refractive index of the optical thin film being at an intermediate level between the refractive index of the substrate and a refractive index of the transparent electrodes, and a thickness of the optical thin film being in a range of from about 55 to about 100 nm.

In the first embodiment of an electro-optical device, liquid crystals servings as an example of an electro-optical material are sealed between a pair of substrates such as glass substrates. Transparent pixel electrodes made, for example, of an ITO film are arranged in a matrix, for example, on one of the transparent substrates, and counter electrodes made, for example, of an ITO film are arranged on the other of the transparent substrates to face the pixel electrodes. The “substrate” may be a transparent substrate made, for example, of a glass substrate, or may be a stacked layer in which semiconductor elements or wires such as scanning lines or data lines are stacked on the substrate and an interlayer insulating film is formed on an uppermost layer thereof. Typically, the “substrate” means at least one of “the pair of substrates” (i.e., “one of the substrates” and “the other of the substrates”). When operating the electro-optical device, a voltage corresponding to an image signal is applied to a liquid crystal layer disposed between the pixel electrode and the counter electrode, thereby changing the orientation state of liquid crystal molecules. Then, transmittance of light varies from pixel to pixel in accordance with changes in the orientation state of liquid crystal molecules. In this way, the transmittance of light passing through the liquid crystal layer varies in accordance with the image signal, thereby enabling to display images.

In some embodiments, an optical thin film having a refractive index being at an intermediate level of the refractive indices of the substrate and the transparent electrodes is stacked between the substrate and the transparent electrodes. In this disclosure, the “intermediate level” means that the refractive index of the optical thin film is smaller than that of the substrate and greater than that of the transparent electrodes when the refractive index of the substrate is greater than that of the transparent electrodes, and that the refractive index of the optical thin film is greater than that of the substrate and smaller than that of the transparent electrodes when the refractive index of the substrate is smaller than that of the transparent electrodes. In other words, the “intermediate level” corresponds to a value between both of the refractive indices. Therefore, the meaning of the “intermediate level” is not limited to a middle value. In this embodiment, a substrate having a refractive index, for example, of 1.4, an optical thin film having a refractive index, for example, in a range of from about 1.6 to about 1.8 (i.e., greater than about 1.6 and smaller than about 1.8) and disposed adjacent to the substrate, and a transparent electrodes having a refractive index, for example, of 2.0 are stacked in this order. Therefore, the optical thin film increases transmittance of light when the light incident on the pixel electrode is output toward the substrate after passing through the transparent electrodes. In other words, when the transparent electrodes are stacked directly on the substrate without providing any intermediate layer therebetween, relatively great interfacial reflection will be generated at an interface between the transparent electrodes and the substrate, due to relatively great difference between the refractive indices of the substrate and the transparent electrodes. In contrast, according to the embodiment, it is possible to reduce the interfacial reflection by using the optical thin film having an intermediate refractive index. More specifically, since both the difference in refractive index between the transparent electrodes and the optical thin film and the difference in refractive index between the optical thin film and the substrate are smaller than the difference in refractive index between the transparent electrodes and the substrate, both the amount of interfacial reflection between the transparent electrodes and the optical thin film and the amount of interfacial reflection between the optical thin film and the substrate are smaller than the amount of interfacial reflection between the transparent electrodes and the substrate. Moreover, the total amount of the inter facial reflection between the transparent electrodes and the optical thin film and the interfacial reflection between the optical thin film and the substrate are smaller than the amount of interfacial reflection between the transparent electrodes and the substrate. Therefore, even when the light is incident from the substrate, it is possible to increase the transmittance of light when the light is output toward the transparent electrodes after passing through the substrate. In other words, by forming the optical thin films immediately below the pixel electrode and lie counter electrode serving as the transparent electrodes, respectively, it is possible to further increase the transmittance at the display area of the electro-optical device.

In addition, in the embodiment, the thickness of the optical thin film is in a range of from about 55 to about 100 nm. Therefore, it is possible to reduce the interfacial reflection and effectively improve the transmittance characteristics without causing any reduction in the transmittance due to optical absorption in the optical thin film.

As described above, according to the first embodiment of an electro-optical device, since the optical thin film reduces the interfacial reflection, it is possible to effectively improve the transmittance characteristics, thereby enabling a high-quality display.

In an aspect of the first embodiment of an electro-optical device, the transparent conductive film is an ITO film.

According to the above aspect, by providing the optical thin film between the substrate and the transparent electrodes made of the ITO film having a relatively low transmittance, it is possible to effectively improve the entire transmittance of the substrate, the optical thin film and the transparent electrodes.

In another aspect of the first embodiment of an electro-optical device, the refractive index of the optical thin film is in the range of from about 1.6 to about 1.8.

According to the above aspect, by stacking the optical thin film between a glass substrate having a refractive index, for example, of about 1.4 and a transparent electrodes made of an ITO film having a refractive index, for example, of about 2.0, it is possible to further effectively reduce the interfacial reflection.

In a further aspect of the first embodiment of an electro-optical device, the optical absorption coefficient of the optical thin film is smaller than the optical absorption coefficient of the transparent conductive film.

According to the above aspect, it is possible to reduce or prevent optical loss, i.e., reduction in the light intensity hen the light passes through the optical thin film, thereby more securely improving transmittance characteristics thereof.

In a still further aspect of the first embodiment of an electro-optical device, the optical thin film is an inorganic nitride film or an inorganic oxide nitride film.

According to the above aspect, since the optical thin film is a nitride film such as silicon nitride (SiN) or an oxide nitride film such as silicon oxide nitride (SiON), it is possible to easily control the refractive index of the optical thin film to be at an intermediate level between the refractive indices of the transparent electrodes and the substrate. Therefore, it is possible to improve the transmittance characteristics in an easy and secure manner.

In a still further aspect of the first embodiment of an electro-optical device, the refractive index of the optical thin film gradually approaches the refractive index of the transparent electrodes as the distance from the substrate in the thickness direction of the optical thin film increases.

According to the above aspect, the refractive index of the optical thin film gradually approaches the refractive index of the transparent electrodes as the distance from the substrate in the thickness direction of the optical thin film, i.e., in the stacking direction on the substrate (i.e., in a direction toward an upper layer) increases. In other words, the refractive index of the optical thin film varies, for example, stepwise or continuously in the optical thin film in a direction from the substrate toward the transparent electrodes. Preferably, the refractive index of the optical thin film at a first portion joining with the substrate is the same as the refractive index of the substrate, and the refractive index of the optical thin film at a second portion joining with the transparent electrodes is the same as the refractive index of the transparent electrodes. Moreover, the refractive index of the optical thin film between the first portion and the second portion varies in proportion to the distance from the substrate. Therefore, it is possible to reduce or prevent the interfacial reflection due to the difference of refractive indices at the interfaces between the transparent electrodes and the optical thin film and between the optical thin film and the substrate. Moreover, since the refractive index of the optical thin film gradually vanes in the optical thin film, the interfacial reflection due to the difference of refractive index within the optical thin film is rarely produced.

According to the above aspect where the refractive index of the optical thin film approaches the refractive index of the transparent electrodes, the substrate includes a silicon oxide film, and the optical thin film is made of a silicon oxide nitride film, the oxygen concentration of which gradually decreases as the distance from the substrate in the thickness direction of the optical thin film increases.

In this case, the refractive index of the optical thin film increases stepwise or continuously in the optical thin film in a direction from the substrate toward the transparent electrodes in accordance with the changes of oxygen concentration in the optical thin film and finally approaches the refractive index of the transparent electrodes. Therefore, it is possible to reduce or prevent the interfacial reflection due to the difference of refractive indices at the interfaces between the transparent electrodes and the optical thin film and between the optical thin film and the substrate. Moreover, since the refractive index of the optical thin film gradually varies in accordance with the changes of oxygen concentration in the optical thin film, the interfacial reflection due to the difference of refractive index within the optical thin film is rarely produced. The upper layer portion of the optical thin film may be made of a silicon nitride film so that the oxygen concentration in the upper layer portion becomes zero (0).

According to a second embodiment of an electro-optical device, there is provided an electro-optical device including a substrate; a plurality of transparent electrodes disposed above the substrate and made of an ITO (Indium Tin Oxide) film; an optical thin film disposed between the substrate and the transparent electrodes, the refractive index of the optical thin film being equal to the refractive index of the transparent electrodes, and the optical absorption coefficient of the optical thin film being smaller than the optical absorption coefficient of the transparent electrodes; and the thickness of the transparent electrodes combined with the thickness of the optical thin film is in a range of from about 120 to about 160 nm.

In the second embodiment of an electro-optical device, the second electro-optical device is operated to display images in a substantially similar manner to the case of the first electro-optical device related to the invention.

In the embodiment, an optical thin film having the same refractive index as the transparent electrodes and an optical absorption coefficient smaller than that of the transparent electrodes is disposed between the substrate and the transparent electrodes. The phrase “the same refractive index as the transparent electrodes” means that the refractive index of the optical thin film is close enough to that of the transparent electrodes to an extent that the interfacial reflection due to the difference of refractive indices at the interfaces between the optical thin film and the transparent film is rarely produced. In other words, it should be interpreted to include the case where both refractive indices are substantially equal to each other, in addition to the case where both refractive indices are literally the same. For example, the case where the refractive index of the transparent electrodes is 2.0 and the refractive index of the optical thin film is in a range, for example, of from about 1.8 to about 2.0 can be also interpreted to belong the “the same refractive index as the transparent electrodes”. Therefore, since the optical thin film has the same refractive index as the transparent electrodes, the interfacial reflection at the interface between the optical thin film and the transparent electrodes is rarely produced. Moreover since the optical absorption coefficient of the optical thin film is smaller than that of the transparent electrodes, the optical loss (i.e., reduction in the light intensity) when the light passes through the optical thin film is smaller than the optical loss when the light passes through the transparent electrodes.

In addition, in the embodiment, the total thickness of the transparent electrodes and the optical thin film is in a range of from about 120 to about 160 nm (i.e., greater than about 120 nm and smaller than about 160 nm). In other words, the total thickness of the transparent electrodes and the optical thin film is in the range of about 140 mm±20 nm, which is a quarter of the wavelength in the middle wavelength band near 560 nm (i.e., a wavelength band with high human visual sensitivity). Therefore, the phase of the light incident from the transparent electrodes is shifted by about a half wavelength from the phase of the light reflected from the surface of the transparent electrodes and the phase of the light reflected from the interface between the optical thin film and the substrate, thereby canceling the intensity thereof, in other words, the light reflected from the surface of the transparent electrodes and the light reflected from the interface between the optical thin film and the substrate are rarely produced. Accordingly, it is possible to increase the entire transmittance of the transparent electrodes, the optical thin film and the substrate. Moreover, as described above, since the optical loss (i.e., reduction in the light intensity) when the light passes through the optical thin film is smaller than the optical loss when the light passes through the transparent electrodes, by setting the total thickness of the optical thin film and the transparent electrodes in a range of from about 120 to about 160 nm and increasing the thickness of the optical thin film within the total thickness range (i.e., increasing the proportion of the thickness of the optical thin film in the total thickness), it is possible to further improve the transmittance characteristics.

Since the optical thin film is made, for example, of a silicon nitride film or a silicon oxide nitride film, which is cheaper than the ITO film, it is possible to improve the transmittance characteristics with the reduction in manufacturing cost.

In an aspect of the second embodiment of an electro-optical device, the refractive index of the optical thin film is in a range of about 1.8 to about 2.0.

According to the above aspect, the phase of the light incident from the transparent electrodes is shifted by about a half wavelength from the phase of the light reflected from the surface of the transparent electrodes and the phase of the light reflected from the interface between the optical thin film and the substrate, thereby canceling the intensity thereof. Accordingly, it is possible to securely improve the transmittance characteristics.

In another aspect of the second embodiment of an electro-optical device, the optical thin film is an inorganic nitride film or an inorganic oxide nitride film.

According to the above aspect, since the optical thin film is a nitride film such as silicon nitride (SiN) or an oxide nitride film such as silicon oxide nitride (SiON). It is possible to easily control the optical thin film to have the same refractive index as the transparent electrodes (i.e., the ITO film). Moreover, since the optical thin film is made, for example, of a silicon nitride film or a silicon oxide nitride film, which is cheaper than the ITO film, it is possible to improve the transmittance characteristics with the reduction in manufacturing cost.

According to an embodiment of a panel for the first embodiment of an electro-optical device, there is provided a panel for an electro-optical device including a substrate; a plurality of transparent electrodes disposed above the substrate and made of a transparent conductive film; and an optical thin film disposed between the substrate and the transparent electrodes, the refractive index of the optical thin film being at an intermediate level between the refractive indices of the substrate and the transparent electrodes and the thickness of the optical thin film being in a range of from about 55 to about 100 nm.

In the embodiment of a panel for the first embodiment of an electro-optical device, similar to the first embodiment of an electro-optical device, since the optical thin film reduces the interfacial reflection, it is possible to effectively improve the transmittance characteristics.

According to an embodiment of a panel for the second embodiment of an electro-optical device, there is provided a panel for an electro-optical device including a substrate; a plurality of transparent electrodes disposed above the substrate and made of an ITO (Indium Tin Oxide) film; and an optical thin film disposed on the transparent electrodes between the substrate and the transparent electrodes the refractive index of the optical thin film being equal to the refractive index of the transparent electrodes, and the optical absorption coefficient of the optical thin film being smaller than the optical absorption coefficient of the transparent electrodes, wherein the total thickness of the transparent electrodes and the optical thin film is in a range of from about 120 to about 160 nm.

In the embodiment, of a panel for the second embodiment of an electro-optical device, similar to the case of the second embodiment of an electro-optical device, the light reflected from the surface of the transparent electrodes and the light reflected from the interface between the optical thin film, and the substrate are rarely produced. Accordingly, it is possible to increase the entire transmittance of the transparent electrodes, the optical thin film and the substrate.

According to an embodiment of an electronic apparatus, there is provided an electronic apparatus having the first embodiment or second embodiment of an electro-optical device.

In the embodiment of an electronic apparatus, since the electronic apparatus is configured to have the first or second embodiment of an electro-optical device related to the invention, it is possible to realize various types of electronic apparatuses capable of displaying high-quality images, such as a projection-type display apparatus, a television, a mobile phone, an electronic pocket book, a word processor, a view finder type or monitor direct vision-type video tape recorder, a work station, a television phone, a POS terminal, and/or an apparatus having a touch panel. Moreover, the electro-optical device may be applied to an electrophoresis device such as an electronic paper, an electron emitter (for example, FEDs (Field Emission Display) and SEDs (Surface-conduction Electron-emitter Display)), and a display apparatus using the electrophoresis device and the electron emitter.

According to a method of manufacturing the first embodiment of an electro-optical device, there is provided a method of manufacturing an electro-optical device in which a plurality of transparent electrodes is disposed above a substrate, the method including: forming an optical thin film on the substrate so that the optical thin film and the substrate are adjacent to each other, the refractive index of the optical thin film being at an intermediate level between the refractive indices of the substrate and the transparent electrodes, and the thickness of the optical thin film being in a range of from about 55 to about 100 nm; and stacking a transparent conductive film on an upper side of the optical thin film so that the transparent conductive film and the optical thin film are adjacent to each other, thereby forming the transparent electrodes.

In the method of manufacturing the first embodiment of an electro-optical device, it is possible to manufacture the first embodiment of an electro-optical device. In this case, since the optical thin film decreases the interfacial reflection, it is possible to effectively improve the transmittance characteristics.

In an aspect of the method of manufacturing the first embodiment of an electro-optical device, the substrate includes a silicon oxide film, and when forming the optical thin film, a silicon oxide nitride film is stacked on the substrate with a supply of oxygen gas, the amount of supplied oxygen gas being controlled to decrease as the thickness of the stacked silicon oxide nitride film increases.

According to the above aspect, it is possible to form the optical thin film such that the refractive index of the optical thin film varies stepwise or continuously in the optical thin film, in a direction from the substrate toward the transparent electrodes. Therefore, it is possible to reduce or prevent the interfacial reflection due to the difference of refractive indices at the interfaces between the transparent electrodes and the optical thin film and between the optical thin film and the substrate. Moreover, since the refractive index of the optical thin film gradually varies, the interfacial reflection due to the difference of refractive index within the optical thin film is rarely produced. When forming the optical thin filter, the silicon nitride film may be stacked without the supply of oxygen gas after decreasing the amount of oxygen gas supplied.

According to a method of manufacturing the second embodiment of an electro-optical device, there is provided a method of manufacturing an electro-optical device in which a plurality of transparent electrodes is disposed above a substrate, the method including forming an optical thin film on the substrate so that the optical thin film and the substrate are adjacent to each other, the refractive index of the optical thin film being equal to the refractive index of the transparent electrodes, and the optical absorption coefficient of the optical thin film being smaller than the optical absorption coefficient of the transparent electrodes; and stacking an ITO (Indium Tin Oxide) film on an upper side of the optical thin film so that the ITO film and the optical thin film are adjacent to each other, thereby forming the transparent electrodes, wherein, when forming the optical thin film and the transparent electrodes, the total thickness of the transparent electrodes and the optical thin film being controlled to be in a range of from about 120 to about 160 nm.

In the method of manufacturing the second embodiment of an electro-optical device, it is possible to manufacture the second embodiment of an electro-optical device. In this case, the light reflected from the surface of the transparent electrodes and the light reflected from the interface between the optical thin film and the substrate are rarely produced. Accordingly, it is possible to increase the entire transmittance of the transparent electrodes, the optical thin film and the substrate.

These functions of the embodiments will be apparent from the exemplary embodiments described below.

### BRIEF DESCRIPTION OF THE DRAWINGS

Embodiments will be described with reference to the accompanying drawings, wherein like numbers reference like elements.

FIG. 1 is a plan view showing the entire structure of a liquid crystal device according to a first embodiment.

FIG. 2 is a sectional view along II-II line in FIG. 1.

FIG. 3 shows an equivalent circuit with various types of elements in pixels of the liquid crystal device according to the first embodiment.

FIG. 4 is an enlarged sectional view showing a portion indicated by C1 in FIG. 2.

FIG. 5 is a graph illustrating the relation between the thickness of an optical thin film and transmittance thereof according to the first embodiment.

FIG. 6 is a graph illustrating the relation between the thickness of an optical thin film and transmittance thereof according to a second embodiment.

FIG. 7 is an explanatory diagram for illustrating dependence of a refractive index on a distance from a substrate surface in an optical thin film according to a third embodiment.

FIGS. 8A to 8C are sectional views showing the process sequence for manufacturing the optical thin film of the liquid crystal device according to the first or third embodiment.

FIGS. 9A to 9C are sectional views showing the process sequence for manufacturing the optical thin film of the liquid crystal device according to the second embodiment.

FIG. 10 is a plan view showing a structure of a projector serving as an example of an electronic apparatus employing an embodiment of an electro-optical device.

### DESCRIPTION OF EXEMPLARY EMBODIMENTS

Hereinafter, exemplary embodiments will be described with reference to drawings. A TFT active-matrix-driven liquid crystal device of driver built-in type that is an example of an embodiment of an electro-optical device will be described by way of example.

### First Embodiment

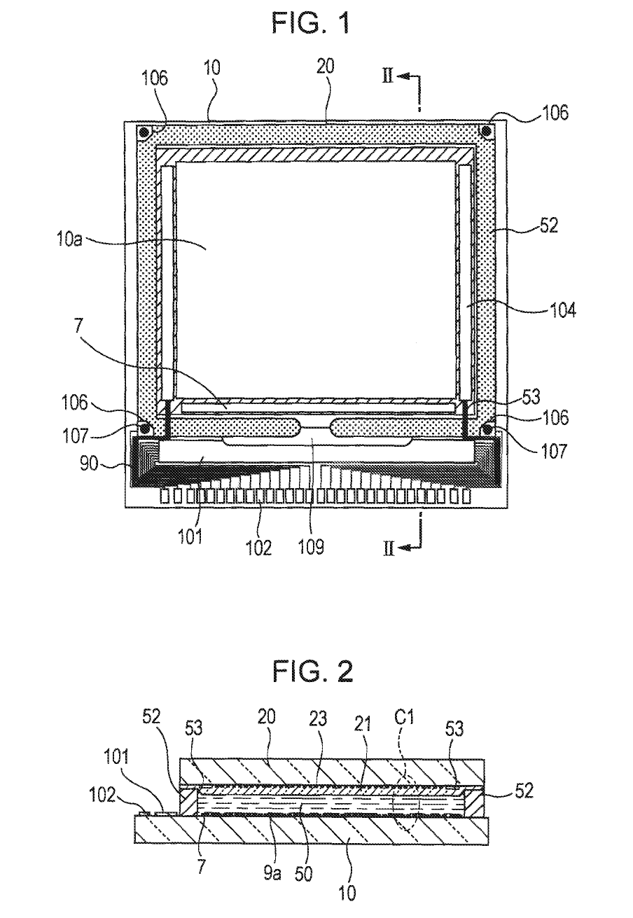

Hereinafter, a liquid crystal device according to a first embodiment will be described with reference to FIGS. 1 to 5.

First, the entire structure of the liquid crystal device according to this embodiment will be described with reference to FIGS. 1 and 2, in which FIG. 1 is a plan view showing the entire structure of a liquid crystal device according to a first embodiment, and FIG. 2 is a sectional view along II-II line in FIG. 1.

Referring to FIGS. 1 and 2, in the liquid crystal device according to this embodiment, a TFT array substrate 10 and a counter substrate 20 are disposed so as to be opposed to each other. The TFT array substrate 10 and the counter substrate 20 are examples of substrates related to embodiments. The TFT array substrate 10 is, for example, a quartz substrate, a glass substrate or a silicon substrate and the counter substrate 20 is, for example, a quartz substrate or a glass substrate. The TFT array substrate 10 and the counter substrate 20 are bonded to each other with a sealing material 52 provided on a sealing area around an image display area 10a. A liquid crystal layer 50 is sealed between the TFT array substrate 10 and the counter substrate 20 by the sealing material 52 and an encapsulating material 109.

In FIG. 1, a frame-shaped light shielding film 53 that defines a frame area of the image display area 10a is provided on the counter substrate 20 side parallel with the inside of a sealing area where the sealing material 52 is provided. On a certain portion of a peripheral area located outside of the sealing area where the sealing material 52 is provided, a data-line driving circuit 101 and connection terminals 102 for providing connections to an external circuit are provided along one side of the TFT array substrate 10. A sampling circuit 7 is provided along the one side on an inner side of the inside of the sealing area so as to be covered by the frame-shaped light shielding film 53. In addition, scanning line driving circuits 104 are provided along two sides adjoining the one side so as to be covered by the frame-shaped light shielding film 53. In addition, on the TFT array substrate 10, vertical conduction terminals 106 for connecting the substrates 10 and 20 to each other with conductive particles 107 are disposed at portions facing four corner parts of the counter substrate 20. By means of this arrangement, it is possible to electrically connect the TFT array substrate 10 and the counter substrate 20 to each other.

On the TFT array substrate 10, drag wires 90 are provided to electrically connect the connection terminals 102 for providing connections to an external circuit, the data-line driving circuit 101, the scanning-line driving circuits 104 and the vertical conduction terminals 106 to each other.

Referring to FIG. 2, above the TFT array substrate 10, there is formed a stack structure where TFTs as driving elements for pixel switching or wires such as scanning lines and data lines are formed. On the image display area 10a, pixel electrodes 9a made of a transparent film such as an ITO film are provided over the TFTs for pixel switching and the wires such as the scanning lines and the data lines. The pixel electrodes 9a are an example of transparent electrodes related to embodiments. An alignment film is formed over the pixel electrodes 9a. Meanwhile, the light shielding film 23 is formed on the counter substrate 20 so as to face the TFT array substrate 10. In addition, similar to the case of the pixel electrodes 9a, counter electrodes 21 made of a transparent conductive film such as an ITO film are formed over the light shielding film 23 so as to face the pixel electrodes 9a. Similar to the pixel electrodes 9a, the counter electrodes 21 are an example of transparent electrodes related to embodiments. Another alignment film is formed over the counter electrodes 21. Moreover, the liquid crystal layer 50 is composed, for example, of liquid crystal prepared by blending one kind or several kinds of nematic liquid crystal, and has a given orientation state between the pair of a alignment films. Although not shown in FIG. 2, optical thin films to be described later are formed immediately below the pixel electrodes 9a and the counter electrodes 21 which are disposed on the TFT array substrate 10 and the counter substrate 20, respectively.

Although not shown in drawings, above the TFT array substrate 10, an inspection circuit for inspecting the quality and defects of the liquid crystal device at the time of manufacturing and shipping or an inspection patter may be formed together with the data-line driving circuit 101 and the scanning-line driving circuits 104.

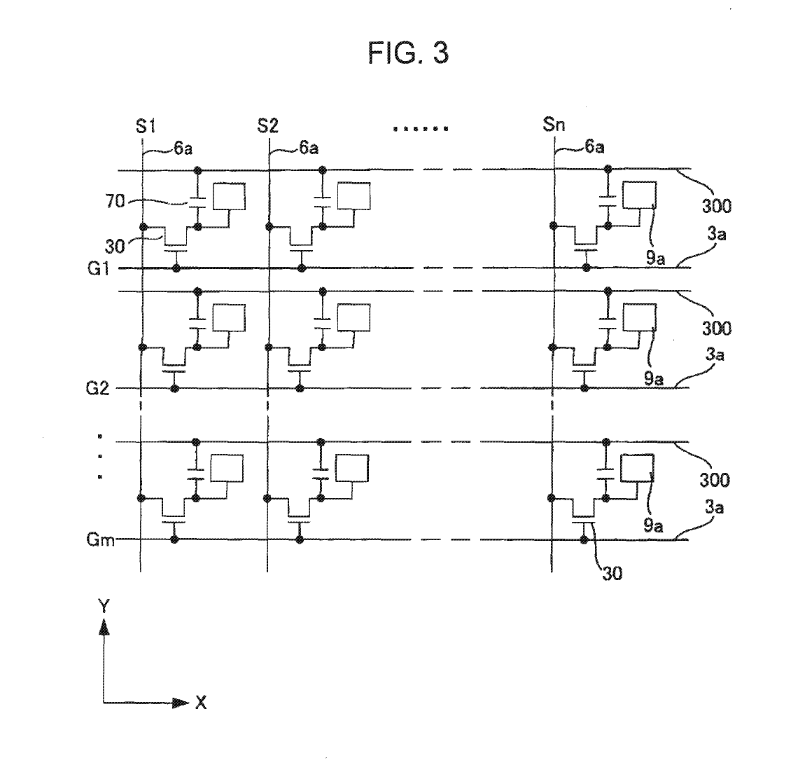

Next, the electrical structure of a pixel part of the liquid crystal device according to this embodiment will be described with reference to FIG. 3 which shows an equivalent circuit with various types of elements in pixels of the liquid crystal device according to the first embodiment.

Referring to FIG. 3, one of the pixel electrodes 9a and one of the TFTs 30 for controlling the switching of the pixel electrodes 9a are formed in each of a plurality of pixels formed in a matrix and constituting the image display area of the liquid crystal device according to this embodiment. The data lines 6a to which image signals are supplied are electrically connected to the sources of the TFTs 30. Image signals S1, S2, Sn, which are written to the data lines 6a, may be supplied may be supplied in this order line sequentially, or may be supplied to a plurality of data lines 6a adjacent to each other in groups.

Scanning lines 3a are electrically connected to gates of the TFTs 30 such that scanning signals G1, G2, . . . , Gm are applied in a pulse manner at a given timing, to the scanning lines 3a in this order line sequentially. The pixel electrodes 9a are electrically connected to drains of the TFTs 30. The pixel electrodes 9a write the image signals S1, S2, . . . , Sn supplied from the data lines 6a at a given timing by switching off the TFTs 30 serving as a switching element during a certain period.

The image signals S1, S2, . . . , Sn, which have been written to the liquid crystal layer 50 (see FIG. 2 for reference) via the pixel electrodes 9a, are maintained between the counter electrodes 21 formed above the counter substrate 20 for a certain period. In liquid crystal layer 50, the orientation and order of molecule assembly are changed depending on applied voltage level so as to modulate light, enabling grayscale display. In the case of a normally white mode, transmittance for incident light decreases in accordance with the voltage applied on a pixel basis, while in the case of a normally black mode, transmittance for incident light increases in accordance with the voltage applied on a pixel basis. As a whole, light having contrast in accordance with the image signals is output from the liquid crystal device.

In order to prevent the leakage of the maintained image signals, storage capacitors 70 are provided in parallel with a liquid crystal capacitance formed between the pixel electrodes 9a and the counter electrodes 21 (see FIG. 2 for reference). Each of the storage capacitors 70 has one electrode thereof connected to the drain of a corresponding one of the TFTs 30 and the other electrode thereof connected to a corresponding capacitance wire 300 with a fixed potential so as to have constant potential.

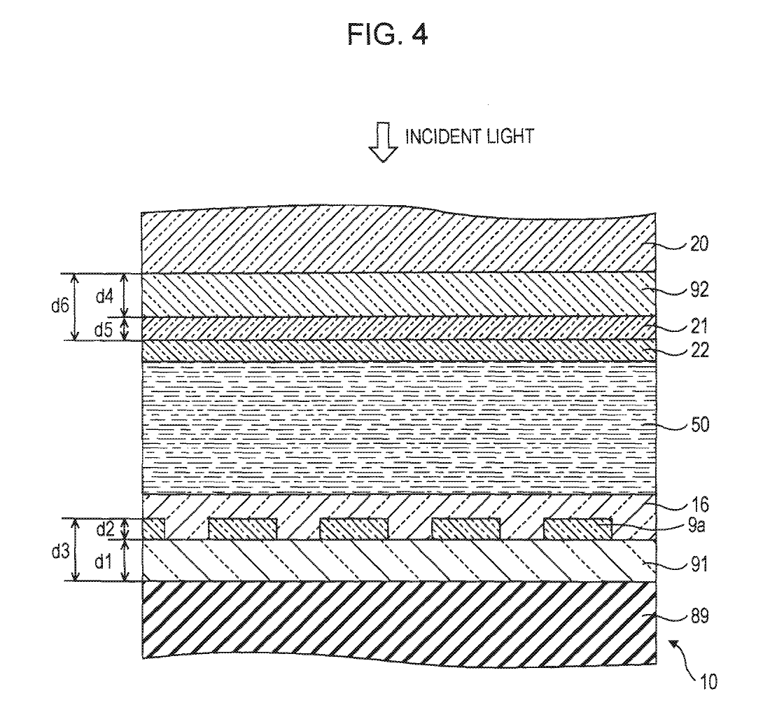

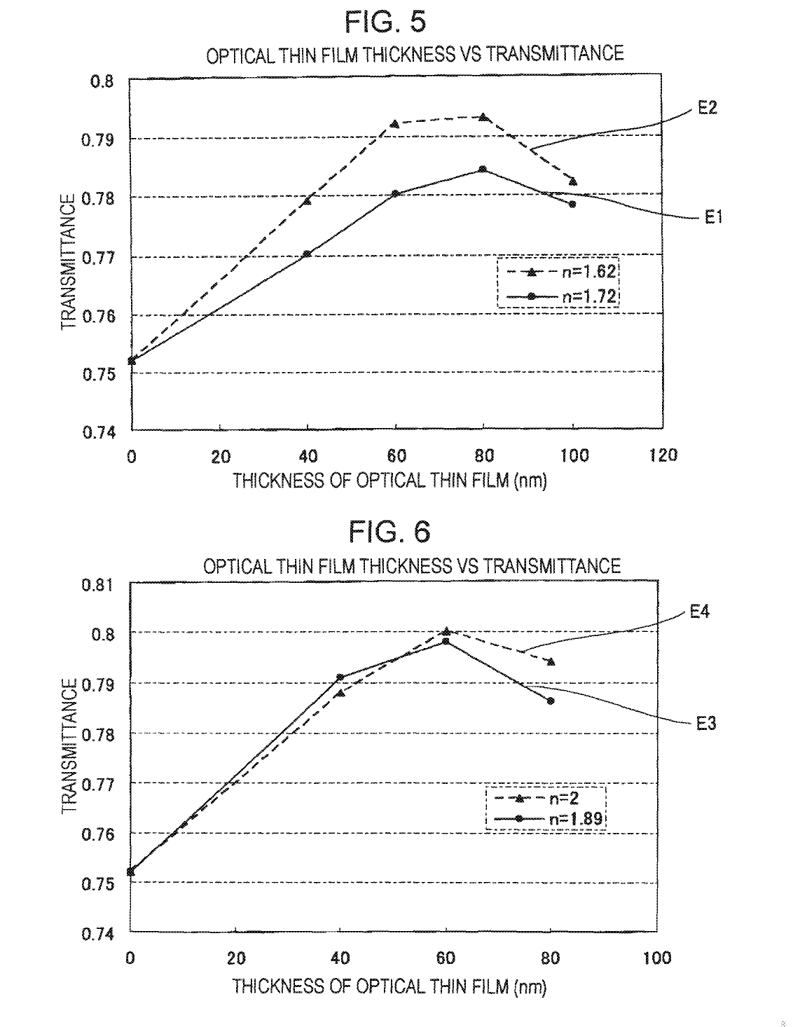

Next, an optical thin film according to this embodiment will be described with reference to FIGS. 4 and 5, in which FIG. 4 is an enlarged sectional view showing a portion indicated by C1 in FIG. 2, and FIG. 5 is a graph illustrating the relation between the thickness of an optical thin film and transmittance thereof according to the first embodiment. In FIG. 4, the light shielding film 23 FIG. 2 is not shown.

Referring to FIG. 4, various layers including the TFTs 30 and wires such as the scanning lines 3a or the data lines 6a are formed above the TFT array substrate 10 and an interlayer insulating film 89 is formed over these layers. In other words, above the TFT array substrate 10, the various layers including the TFTs 30 and the wires such as the scarring lines 3a or the data lines 6a and the interlayer insulating film 89 are formed. The interlayer insulating film 89 is made of an NSG (non-doped silicate glass) or silicon oxide. The interlayer insulating film 89 may be made, for example, of a silicate glass such as PSG (phosphosilicate glass), BSG (borosilicate glass) and BPSG (borophosphosilicate glass), or silicon oxide. An optical thin film 91 to be described later and the pixel electrode 9a are stacked above the interlayer insulating film 89 in this order. Moreover, an alignment film 16 made, for example, of a transparent organic material such as polyimide is formed above the pixel electrode 9a. Another optical thin film 92 to be described later and the counter electrode 21 are stacked on the counter substrate 20 in this order. Moreover, another alignment film 22 made, for example, of a transparent organic material such as polyimide is formed on the counter electrode 21. The liquid crystal layer 50 has a given orientation state between the pair of the alignment films 16 and 22.

As illustrated in FIG. 4, in this embodiment, the optical thin film 91 is stacked between the interlayer insulating film 89 and the pixel electrode 9a. In other words, the interlayer insulating film 89, the optical thin film 91 and the pixel electrode 9a are stacked above the TFT array substrate 10 in this order. In this embodiment, the refractive index of the optical thin film 91 is at an intermediate level for example, in a range of from about 1.6 and about 1.8) between the refractive index of the interlayer insulating film 89 and the refractive index of the pixel electrode 9a made of an ITO film. Specifically, the refractive index of the interlayer insulating film 89 made of an NSG (or silicon oxide) is about 1.4, and the refractive index of the pixel electrode 9a made of an ITO film is about 2.0. Meanwhile, the refractive index of the optical thin film 91 is set in a range of from about 1.6 and about 1.8. The optical thin film 91 is made, for example, of silicon nitride (SiN) or silicon oxide nitride (SiON). Therefore, the optical thin film 91 increases transmittance of light when the light incident on the pixel electrode 9a via the counter substrate 20 and the liquid crystal layer 50 is output toward the interlayer insulating film 89 after passing through the pixel electrode 9a. In other words, when the pixel electrode 9a is stacked directly on the interlayer insulating film 89 without providing any intermediate layer therebetween, relatively great interfacial reflection will be generated at an interface between the pixel electrode 9a and the interlayer insulating film 89, due to relatively great difference (i.e., refractive index difference of about 0.6) between the refractive indices of the interlayer insulating film 89 and the pixel electrode 9a. In contrast, according to this embodiment, it is possible to reduce the interfacial reflection by using the optical thin film 91 having an intermediate refractive index (i.e., refractive index in a range of from about 1.6 to about 1.8). More specifically, both the difference of the refractive indices (i.e., refractive index difference within a range of from about 0.2 to about 0.4) between the pixel electrode 9a and the optical thin film 91 and the difference of the refractive indices (i.e., refractive index difference within a range of from about 0.2 to about 0.4) between the optical thin film 91 and the interlayer insulating film 89 are smaller than the difference of the refractive indices (i.e., refractive index difference of about 0.6) between the pixel electrode 9a and the interlayer insulating film 89. Accordingly, both the amount of interfacial reflection between the pixel electrode 9a and the optical thin film 91 and the amount of interfacial reflection between the optical thin film 91 and the interlayer insulating film 89 are smaller than the amount of interfacial reflection between the pixel electrode 9a and the interlayer insulating film 89. Moreover, the total amount of the interfacial reflection between the pixel electrode 9a and the optical thin film 91 and interfacial reflection between the optical thin film 91 and the interlayer insulating film 89 are smaller than the amount of interfacial reflection between the pixel electrode 9a and the interlayer insulating film 89. Therefore, it is possible to increase the transmittance of light when the light is output toward the interlayer insulating film 89 (i.e., the TFT array substrate 10) after passing through the pixel electrode 9a.

FIG. 5 illustrates the relation between the thickness of the optical thin film and transmittance when a simulation in which the thickness and refractive index of the optical thin film were changed was performed for a stack structure where the optical thin film made, for example, of silicon nitride (SiN) or silicon oxide nitride (SiON) and an ITO film are sequentially stacked above a substrate made of silicon oxide. In this case, the transmittance is a ration of an output light intensity to an input light intensity measured after the light has passed through the ITO film, the optical thin film and the substrate.

In FIG. 5, data indicated by E1 represents the relation between the thickness of the optical thin film and the transmittance when the refractive index of the optical thin film is 1.72, and data indicated by E2 represents the relation between the thickness of the optical thin film and the transmittance when the refractive index of the optical thin film is 1.62. As illustrated in FIG. 5, the thickness of the ITO film was 80 mm, and the transmittance measured without provision of the optical thin film (i.e., when the thickness of the optical thin film is zero (0)) was about 0.75.

As illustrated in FIG. 5, in either cases of the optical thin film having refractive indices of 1.72 or 1.62, the transmittance was increased due to the optical thin film, compared with the case in which the optical thin film was eliminated. The transmittance was particularly increased in a range of the optical thin film thickness from about 55 to about 100. Therefore, by providing between the substrate and the ITO film, the optical thin film having a refractive index in a range of from about 1.6 to about 1.8 and a thickness in a range of from about 55 to about 100 nm, it is possible to improve the transmittance characteristics.

Referring to FIG. 4, in this embodiment, the thickness d1 of the optical thin film 91 having a refractive index in a range of from about 1.6 to about 1.8 is set in a range of from about 55 to about 100 nm. Therefore, by providing the optical thin film 91 between the interlayer insulating film 89 and the pixel electrode 9a, it is possible to reduce the interfacial reflection and effectively improve the transmittance characteristics without causing any reduction in the transmittance due to optical absorption in the optical thin film 91. The thickness d2 of the pixel electrode 9a and the total d3 of the thickness d1 of the optical thin film 91 and the thickness d2 of the pixel electrode 9a may be arbitrarily set.

In FIG. 4, according to this embodiment, the optical thin film 92 is stacked between the counter substrate 20 and the counter electrode 21. In other words, the optical thin film 92 and the counter electrode 21 are stacked above the counter substrate 20 in this order. The refractive index of the optical thin film 92 is at an intermediate level between the refractive index of the counter substrate 20 and the refractive index of the counter electrode 21 made of an ITO film. Specifically, the refractive index of the counter substrate 20 made of a glass is about 1.4, and the refractive index of the counter electrode 21 made of an ITO film is about 2.0. Meanwhile, the refractive index of the optical thin film 92 is set in a range of from about 1.6 to about 1.8. The optical thin film 92 is made, for example, of silicon nitride (SiN) or silicon oxide nitride (SiON). Therefore, similar to the case in which the optical thin film 91 is provided above the TFT array substrate 10, the optical thin film 92 increases the transmittance of light when the light incident on the counter substrate 20 is output toward the alignment film 22 and the liquid crystal layer 50 after passing through the counter electrode 21.

Referring to FIG. 4, in this embodiment, the thickness d4 of the optical thin film 92 having a refractive index in a range of from about 1.6 to about 1.8 is set in a range of from about 55 to about 100 nm. Therefore, by providing the optical thin film 92 between the counter substrate 20 and the counter electrode 21, it is possible to reduce the interfacial reflection and effectively improve the transmittance characteristics without causing any reduction in the transmittance due to optical absorption in the optical thin film 92. The thickness d5 of the counter electrode 21 and the total d6 of the thickness d4 of the optical thin film 92 and the thickness d5 of the counter electrode 21 may be arbitrarily set.

In FIG. 4, according to this embodiment, the optical absorption coefficients of the optical thin films 91 and 92 are smaller than the optical absorption coefficient of the ITO film constituting the pixel electrode 9a and the counter electrode 21. Therefore, it is possible to reduce or prevent optical loss (i.e., reduction in the light intensity) when the light passes through the optical thin film 91 or 92, thereby more securely improving transmittance characteristics thereof.

The above-mentioned optical thin film may be provided on either of the TFT array substrate 10 and the counter substrate 20. Even in this case, the optical thin film securely improves the transmittance characteristics.

As described above, according to the liquid crystal device of this embodiment, since the optical thin film 91 or 92 reduces the interfacial reflection, it is possible to effectively improve the transmittance characteristics, thereby enabling a high-quality display.

### Second Embodiment

Hereinafter, a liquid crystal device according to a second embodiment will be described with reference to FIGS. 4 and 6, in which FIG. 6 is a graph illustrating the relation between the thickness of the optical thin film and transmittance thereof according to the second embodiment.

In FIG. 4, the liquid crystal device of this embodiment is different from the liquid crystal device of the first embodiment in that the optical thin film 91 has the same refractive index as the refractive index of the pixel electrode 9a made of the ITO film and an optical absorption coefficient smaller than the optical absorption coefficient of the pixel electrode 9a, and that the total d3 of the thickness d1 of the optical thin film 91 and the thickness d2 of the pixel electrode 9a is in a range of from about 120 to about 160 nm. Moreover, the liquid crystal device of this embodiment is different from the liquid crystal device of the first embodiment in that the optical thin film 92 has the same refractive index as the refractive index of the counter electrode 21 made of the ITO film and an optical absorption coefficient smaller than the optical absorption coefficient of the counter electrode 21, and that the total d6 of the thickness d4 of the optical thin film 92 and the thickness d5 of the counter electrode 21 is in a range of from about 120 to about 160 nm. Other arrangements are the same as those of the liquid crystal device of the first embodiment.

Referring to FIG. 4, according to this embodiment, the optical thin film 91 is stacked between the interlayer insulating film 89 and the pixel electrode 9a. The optical thin film 91 has the same refractive index as the refractive index of the pixel electrode 9a made of the ITO film and an optical absorption coefficient smaller than the optical absorption coefficient of the pixel electrode 9a. In other words, the refractive index of the pixel electrode 9a made of the ITO film is about 2.0 and the refractive index of the optical thin film 91 is set in a range of from about 1.8 to about 2.0. Similar to the case of the first embodiment, the optical thin film 91 is made, for example, of silicon nitride (SiN) or silicon oxide nitride (SiON). Since the optical thin film 91 has the same refractive index as the pixel electrode 9a, the interfacial reflection rarely occurs between the optical thin film 91 and the pixel electrode 9a. In addition, since the optical absorption coefficient of the optical thin film 91 is smaller than the optical absorption coefficient of the pixel electrode 9a made of the ITO film, the optical loss (i.e., reduction in the light intensity) when the light passes through the optical thin film 91 is smaller than the optical loss when the light passes through the pixel electrode 9a.

FIG. 6 illustrates the relation between the thickness of the optical thin film and transmittance when a simulation with changing the thickness and refractive index of the optical thin film were performed to a stack structure where the optical thin film made, for example, of silicon nitride (SiN) or silicon oxide nitride (SiON) and an ITO film are sequentially stacked above a substrate made of silicon oxide.

In FIG. 6, data indicated by E3 represents the relation between the thickness of the optical thin film and the transmittance when the refractive index of the optical thin film is 1.89, and data indicated by E4 represents the relation between the thickness of the optical thin film and the transmittance when the refractive index of the optical thin film is 2.00. As illustrated in FIG. 6, the thickness of the ITO film were 80 n, and the transmittance measured without provision of the optical thin film (i.e., when the thickness of the optical thin film is zero (0)) were about 0.75.

As illustrated in FIG. 6, in either cases of the optical thin film having refractive indices of 1.89 or 2.00, the transmittance was increased thanks to the optical thin film, compared with the case in which the optical thin film was eliminated. The transmittance was particularly increased in a range of the optical thin film thickness from about 40 to about 80 nm. In other words, the transmittance was increased when the total thickness of the ITO film and the optical thin film is in a range of from about 120 to about 160 nm. More specifically, by providing the optical thin film between the substrate and the ITO film so as to have the total thickness of the ITO film and the optical thin film in the range of about 140 nm±20 nm which is a quarter of the wavelength in the middle wavelength band near 560 nm (i.e., a wavelength band with high human visual sensitivity), it is possible to improve the transmittance characteristics.

In FIG. 4, according to this embodiment, the total thickness d2 of the thickness d1 of the optical thin film 91 and the thickness d2 of the pixel electrode 9a is set in a range from about 120 to about 160 nm. In other words, the total thickness d3 of the pixel electrode 9a and the optical thin film 91 is set in the range of about 140 nm±20 nm which is a quarter of the wavelength in the middle wavelength band near 560 nm. Therefore, the phase of the light incident from the pixel electrode 9a is shifted by about a half wavelength from the phase of the light reflected from the surface of the pixel electrode 9a and the phase of the light reflected from the interface between the optical thin film 91 and the interlayer insulating film 89, thereby canceling the intensity thereof. In other words, the light reflected from the surface of the pixel electrode 9a and the light reflected from the interface between the optical thin film 91 and the interlayer insulating film 89 are rarely produced. Accordingly, it is possible to increase the entire transmittance of the pixel electrode 9a, the optical thin film 91 and the interlayer insulating film 89 (i.e., the transmittance of the TFT array substrate 10). Moreover, since the optical loss (i.e., reduction in the light intensity) when the light passes through the optical thin film 91 is smaller than the optical loss when the light passes through the pixel electrode 9a made of the ITO film, by setting the total thickness d3 of the thickness d1 of the optical thin film 91 and the thickness d2 of the pixel electrode 9a in the range of about 120 to about 160 nm and increasing the thickness of the optical thin film 91 within the total thickness range (i.e., increasing the proportion of the thickness d1 of the optical thin film 91 in the total thickness d3), it is possible to further improve the transmittance characteristics.

In FIG. 4, according to this embodiment, the total thickness d6 of the thickness d4 of the optical thin film 92 and the thickness d5 of the counter electrode 21 is set in a range of from about 120 to about 160 nm. In other words, the total thickness d3 of the counter electrode 21 and the optical thin film 92 is set in the range of ±20 nm about 140 nm which is a quarter of the wavelength in the middle wavelength band near 560 nm. Accordingly, similar to the case of the above-mentioned optical thin film 91, it is possible to increase the entire transmittance of the counter electrode 21, the optical thin film 92 and the counter substrate 20. Moreover, as described above, since the optical loss when the light passes through the optical thin film 92 is smaller than the optical loss when the light passes through the counter electrode 21 made of the ITO film, by setting the total thickness d6 of the thickness d4 of the optical thin film 92 and the thickness d5 of the counter electrode 21 in a range from about 120 to about 160 nm and increasing the thickness of the optical thin film 92 within the total thickness range (i.e., increasing the proportion of the thickness d5 of the optical thin film 92 in the total thickness d6), it is possible to further improve the transmittance characteristics.

Since the optical thin films 91 and 92 are made, for example, of silicon nitride (SiN) or silicon oxide nitride (SiON), which is cheaper than the ITO film, it is possible to improve the transmittance characteristics with the reduction in manufacturing cost.

### Third Embodiment

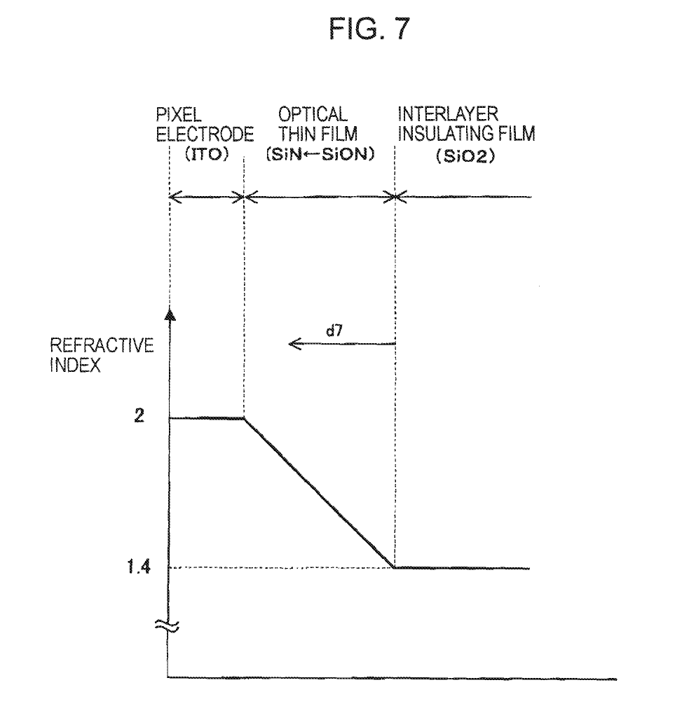

Hereinafter, a liquid crystal device according to a third embodiment will be described with reference to FIGS. 4 and 7, in which FIG. 7 is an explanatory diagram for illustrating dependence of a refractive index on a distance from a substrate surface in an optical thin film according to a third embodiment.

Referring to FIGS. 4 and 7, the liquid crystal device of this embodiment is different from the liquid crystal device of the first embodiment in that the refractive index of the optical thin film 91 gradually approaches the refractive index of the pixel electrode 9a as the distance from the interlayer insulating film 89 increases. Other arrangements are the same as those of the liquid crystal device of the first embodiment.

Specifically, according to this embodiment, in FIGS. 4 and 7, the refractive index of the optical thin film 91 varies continuously in the optical thin film 91 in a direction from the interlayer insulating film 89 toward the pixel electrode 9a. More specifically, as illustrated in FIG. 7, the refractive index of the optical thin film 91 at a portion joining with the interlayer insulating film 89 is the same as the refractive index of the interlayer insulating film 89 (i.e., refractive index of 1.4), and the refractive index of the optical thin film 91 at a portion joining with the pixel electrode 9a is the same as the refractive index of the pixel electrode 9a (i.e., refractive index of 2.0). The refractive index of the optical thin film 91 between the portions joining with the interlayer insulating film 89 and the pixel electrode 9a varies in proportion to the distance d7 from the interlayer insulating film 89. In other words, the refractive index of the optical thin film 91 changes from 1.4 to 2.0 in proportion to the distance d7 in a direction from the interlayer insulating film 89 toward the pixel electrode 9a. Therefore, it is possible to reduce or prevent the interfacial reflection due to the difference of refractive indices at the interfaces between the pixel electrode 9a and the optical thin film 91 and between the optical thin film 91 and the interlayer insulating film 89. Moreover, since the refractive index of the optical thin film 91 gradually varies in proportion to the distance d7, the interfacial reflection due to the difference of refractive index within the optical thin film 91 is rarely produced. The refractive index of the optical thin film 91 may vary stepwise in the optical thin film 91 in a direction from the interlayer insulating film 89 toward the pixel electrode 9a. Even in this case, it is possible to securely reduce or prevent the interfacial reflection due to the difference of the refractive index.

### Manufacturing Method

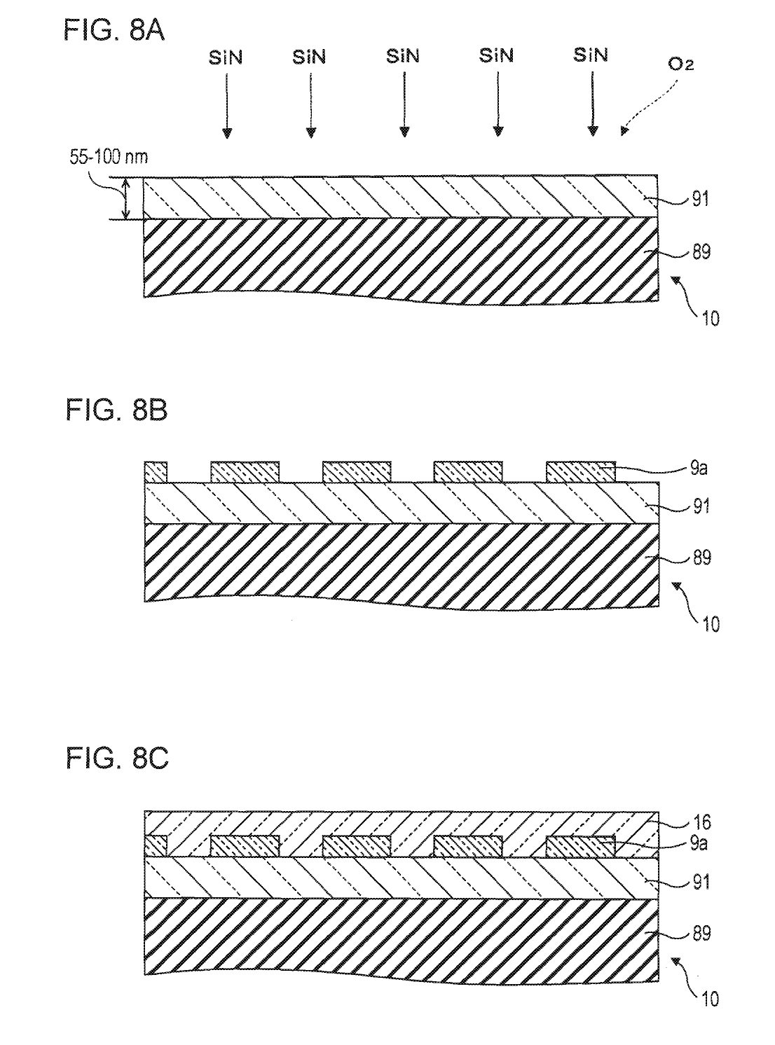

Hereinafter, a method of manufacturing the liquid crystal device according to the first or third embodiment will be described with reference to FIGS. 8A to 8C, which show sectional views showing the process sequence for manufacturing the optical thin film of the liquid crystal device according to the first or third embodiment. In this embodiment, description will be made to the process of forming the optical thin film and the pixel electrode which are parts of the liquid crystal device related to the first or third embodiments.

First, in FIG. 8A, the TFTs 30 for pixel switching (see FIG. 3 for reference) or wires such as the scanning lines 3a or the data lines 6a are formed above the TFT array substrate to using various films such as a conductive film, a semiconductor film or an insulating film, thereby forming the interlayer insulating film 89. The interlayer insulating film 89 are formed by stacking an NSG using a CVD (Chemical Vapor Deposition) method, for example. The interlayer insulating film 89 may be formed by stacking silicate glasses, such as PSG, BSG or BPSG, nitride silicon or silicon oxide. The interlayer insulating film 89 thus formed has a refractive index of about 1.4. Subsequently, the optical thin film 91 is formed on the interlayer insulating film 89 to have a thickness thereof in the range of 55 to 100 nm by stacking a silicon nitride film (SiN) or a silicon oxide nitride film (SiON) using a CVD method with the supply of an oxygen (O₂) gas. In this case, environmental conditions such as the pressure, temperature or amount of the supplied oxygen gas are controlled such that the refractive index of the optical thin film 91 is at an intermediate level between the refractive indices of the interlayer insulating film 89 and the pixel electrode 9a. In this case, the amount of oxygen gas supplied may be controlled to decrease as the thickness of the silicon oxide nitride film (i.e., the optical thin film 91) increases. In this way, it is possible to form the optical thin film 91 such that the refractive index of the optical thin film 91 varies stepwise or continuously in the optical thin film 91 in a direction from the interlayer insulating film 89 toward the pixel electrode 9a.

Next, in FIG. 5B, the ITO film is stacked on the optical thin film 91 to have a certain pattern on the image display area 10a, thereby forming the pixel electrode 9a.

Next, in FIG. 8C, polyimide is applied on the surface of the TFT array substrate 10 to form the alignment film 16. Subsequently, the alignment film 16 is subjected to a rubbing treatment.

Moreover similar to the case of forming the optical thin film 91, the optical thin film 92 is formed on the counter substrate 20 to have a thickness thereof in the range of 55 to 100 nm by stacking a silicon oxide nitride film using a CVD method with the supply of an oxygen gas. Subsequently, the ITO film is stacked on the optical thin film 92 to have a certain pattern on the image display area 10a, thereby forming the counter electrode 21. Next, polymide is applied on the surface of the counter substrate 20 to form the alignment film 22. Subsequently, the alignment film 22 is subjected to a rubbing treatment.

The TFT array substrate 10 and the counter substrate 20 are bonded to each other with a sealing material 52 such that the pixel electrode 9a faces the counter electrode 21. Thereafter, liquid crystals are injected from an injection port provided in a certain portion of the sealing material 52 so as to encapsulate the liquid crystals by the encapsulating material 109 (see FIG. 1 for reference).

According to the method of manufacturing the liquid crystal device described above, it is possible to manufacture the liquid crystal device related to the first or third embodiment.

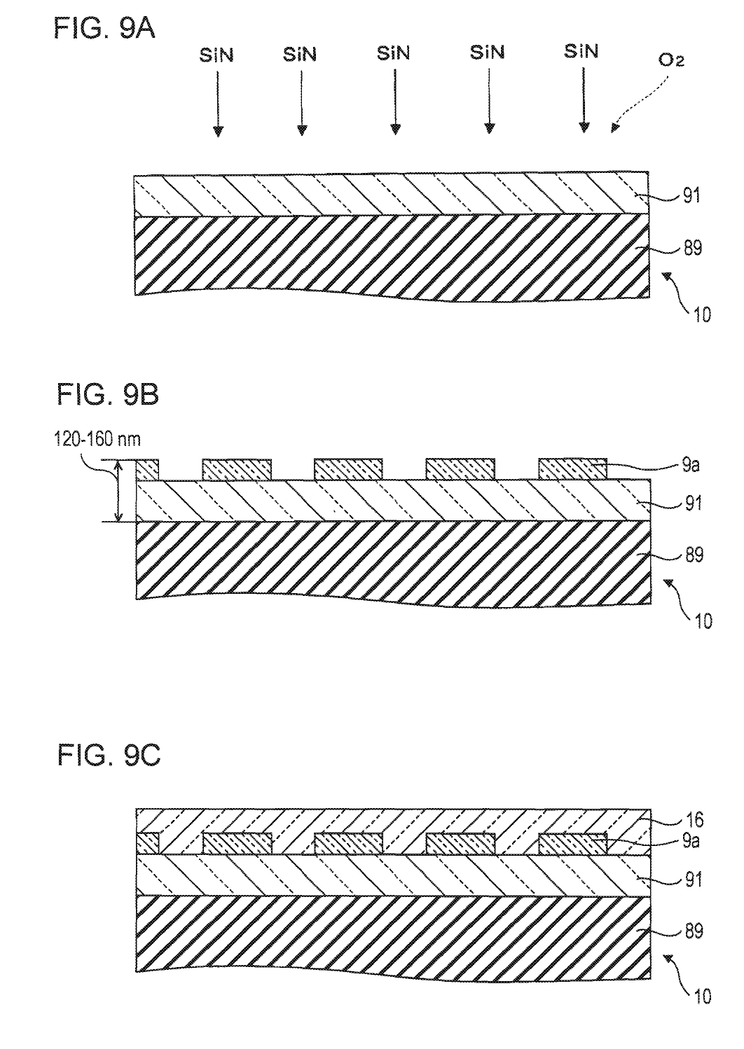

Next, a method of manufacturing the liquid crystal device according to the second embodiment will be described with reference to FIGS. 9A to 9C, which show sectional views showing the process sequence for manufacturing the optical thin film of the liquid crystal device according to the second embodiment. In this embodiment, description will be made to the process of forming the optical thin film and the pixel electrode which are essential parts of the liquid crystal device related to the second embodiment.

First, in FIG. 9A, in as similar manner to the case of the method of manufacturing the liquid crystal device related to the first or third embodiment described with reference to FIG. 8A, the TFTs 30 or wires such as the scanning lines 3a or the data lines 6a are formed above the TFT array substrate 10, thereby forming the interlayer insulating film 89. Subsequently, the optical thin film 91 is formed on the interlayer insulating film 89 by stacking a nitride silicon film (SiN) or a silicon oxide nitride film (SiON) using a CVD method. When forming the optical thin film 91, in this embodiment, the total thickness of the optical thin film 91 and a pixel electrode 9a to be described later is controlled to be in a range from about 120 to about 160 nm. Moreover, in this embodiment, environmental conditions such as the pressure, temperature or amount of oxygen gas are controlled such that the refractive index of the optical thin film 91 is the same as the refractive index of the pixel electrode 9a (i.e., both refractive indices are substantially equal to each other and are in a range from about 1.8 to about 2.0). In addition, as described above, in this embodiment, the optical thin film 91 is made, for example, of silicon nitride (SiN) or silicon oxide nitride (SiON), and the optical absorption coefficient of the optical thin film 91 is smaller than the optical absorption coefficient of the pixel electrode 9a made of the ITO film, as described later.

Next, in FIG. 9B, the ITO film is stacked on the optical thin film 91 to have a certain pattern on the image display area 10a, thereby forming the pixel electrode 9a. When forming the pixel electrode 9a, the total thickness of the optical thin film 91 and the pixel electrode 9a is controlled to be in a range from about 120 to about 160 nm.

Next, in FIG. 9C, polyimide is applied on the surface of the TFT array substrate 10 to form the alignment film 16. Subsequently, the alignment film 16 is subjected to a rubbing treatment.

Thereafter, an optical thin film 92 is formed above the counter substrate 20 in a similar manner to the case of forming the optical thin film 91.

According to the method of manufacturing the liquid crystal device described above, it is possible to manufacture the liquid crystal device related to the second embodiment.

### Electronic Apparatus

Hereinafter, the description will be directed to the case where the above-mentioned liquid crystal device serving as an example of the electro-optical device is applied to various electronic apparatuses.

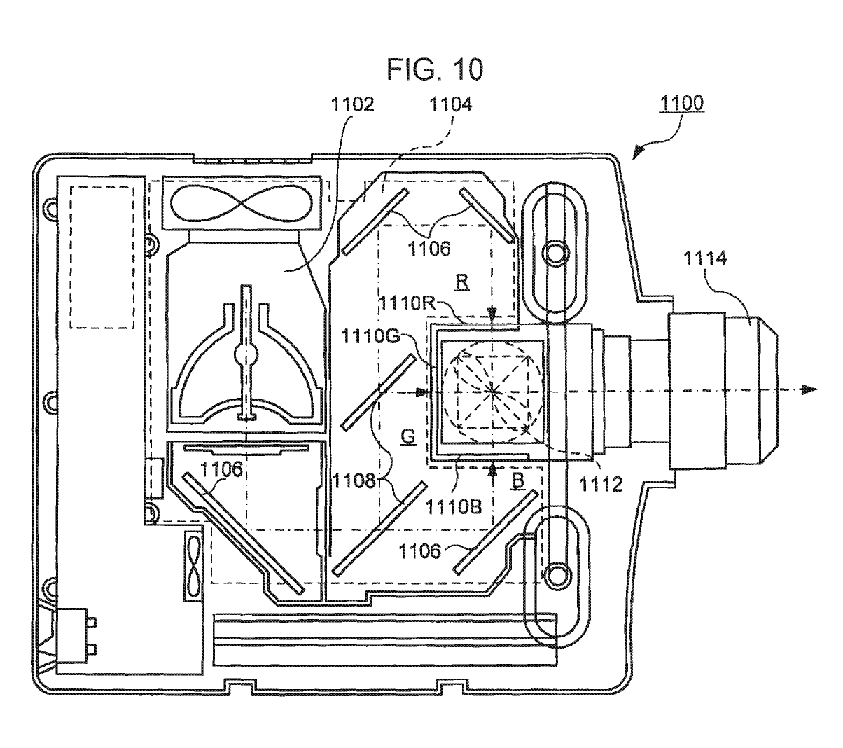

First, a projector having the liquid crystal device as a light valve will be described. FIG. 10 is a plan view showing a structure of the projector. As shown in FIG. 10, a lamp unit 1102 having a white light source such as a halogen lamp is provided inside the projector 1100. The projection light emitted from the lamp unit 1102 is separated into three primary colors of R (red color), G (green color) and B (blue color) by four mirrors 1106 and two dichroic mirrors 1108 disposed in a light guiding part 1104 and then input to liquid crystal panels 1110R, 1110G and 1110B corresponding to the respective primary colors, in which the liquid crystal panels serve as the light valve.

Here, the liquid crystal panels 1110R, 1110G and 1110B have the same structure as that of the liquid crystal device according to the above-mentioned embodiments, and are driven with the primary colors R, G and B supplied from an image signal processing circuit. The light components modulated by the liquid crystal panels 1110R, 1110G and 1110B, respectively, are incident on the dichroic prism 1112 from three directions. In the dichroic prism 1112, the light components of R color and B color are refracted by 90 degrees, while the light component of G color passes therethrough. Therefore, after the images of the respective colors are synthesized, a color image is projected onto a screen through a projection lens 1114.

In this case, for the images passing through the liquid crystal panels 1110R, 1110G and 1110B, it is necessary to reverse the right and left sides of the images passing through the liquid crystal panel 1110G with respect to the images passing through the liquid crystal panels 1110R and 1110B.

Since the light components corresponding to the respective primary colors R, G and B are input to the liquid crystal panels 1110R, 1110G and 1110B through the dichroic mirror 1108, it is not necessary to provide a color filter.

In addition to those described with reference to FIG. 10, examples of the electronic apparatus may include a mobile personal computer, a mobile phone, a liquid crystal television, a view finder type or monitor direct vision-type video tape recorder, a car navigation apparatus, a pager, an electronic pocket book, a calculator, a word processor, a work station, a television phone, a POS terminal, an apparatus having a touch panel, and the like. It is needless to say that embodiments of an electro-optical device can be applied to various types of electronic apparatuses.

It should be understood that the present invention is not limited to the above embodiments, but that various modifications can be made without departing from the scope and spirit of the invention. An electro-optical device, a method of manufacturing the same, and an electronic apparatus with such a modification are also included in technical scope of the invention.

What is claimed is:

1. An electro-optical device, comprising:
a substrate;
a plurality of transparent electrodes disposed above the substrate and made of a transparent conductive film; and
an optical thin film disposed between the substrate and the transparent electrodes, a refractive index of the optical thin film being at an intermediate level between a refractive index of the substrate and a refractive index of the transparent electrodes, and a thickness of the optical thin film being in a range of from about 55 to about 100 nm.

2. The electro-optical device according to claim 1, the transparent conductive film being an ITO (Indium Tin Oxide) film.

3. The electro-optical device according to claim 1, the refractive index of the optical thin film being in a range of from about 1.6 to about 1.8.

4. The electro-optical device according to claim 1, the optical absorption coefficient of the optical thin film being smaller than the optical absorption coefficient of the transparent conductive film.

5. The electro-optical device according to claim 1, the optical thin film being an inorganic nitride film or an inorganic oxide nitride film.

6. The electro-optical device according to claim 1, the refractive index of the optical thin film gradually approaching the refractive index of the transparent electrodes as the distance from the substrate in a thickness direction of the optical thin film increases.

7. The electro-optical device according to claim 6,
the substrate including a silicon oxide film; and
the optical thin film being made of a silicon oxide nitride film, the oxygen concentration of which gradually decreases as the distance from the substrate in the thickness direction of the optical thin film increases.

8. An electro-optical device, comprising
a substrate;
a plurality of transparent electrodes disposed above the substrate and made of an ITO (Indium Tin Oxide) film;
an optical thin film disposed on the transparent electrodes between the substrate and the transparent electrodes, a refractive index of the optical thin film being equal to a refractive index of the transparent electrodes, and an optical absorption coefficient of the optical thin film being smaller than an optical absorption coefficient of the transparent electrodes; and
a total thickness of the transparent electrodes and the optical thin film being from about 120 to about 160 nm.

9. The electro-optical device according to claim 8, the refractive index of the optical thin film being in a range of from about 1.8 to about 2.0.

10. The electro-optical device according to claim 8, the optical thin film being an inorganic nitride film or an inorganic oxide nitride film.

11. A panel for an electro-optical device, comprising:
a substrate;
a plurality of transparent electrodes disposed above the substrate and made of a transparent conductive film; and
an optical thin firm disposed between the substrate and the transparent electrodes, a refractive index of the optical thin film being at an intermediate level between a refractive index of the substrate and a refractive index of the transparent electrodes, and the thickness of the optical thin film being in a range of from about 55 to about 100 nm.

12. A panel for an electro-optical device, comprising:
a substrate;
a plurality of transparent electrodes disposed above the substrate and made of an ITO (Indium Tin Oxide) film;
an optical thin film disposed between the substrate and the transparent electrodes, the refractive index of the optical thin film being equal to the refractive index of the transparent electrodes, and the optical absorption coefficient of the optical thin film being smaller than the optical absorption coefficient of the transparent electrodes; and
the thickness of the transparent electrodes combined with the thickness of the optical thin film is in a range of from about 120 to about 160 nm.

13. An electronic apparatus including the electro-optical device according to claim 1.

14. An electronic apparatus having the electro-optical device according to claim 8.

15. A method of manufacturing an electro-optical device in which a plurality of transparent electrodes is disposed above a substrate, the method comprising:
forming an optical thin film on the substrate so that the optical thin film and the substrate are adjacent to each other, a refractive index of the optical thin film being at an intermediate level between a refractive index of the substrate and a refractive index of the transparent electrodes, and a thickness of the optical thin film being in a range of from about 55 to about 100 nm; and
stacking a transparent conductive film on an upper side of the optical thin film so that the transparent conductive film and the optical thin film are adjacent to each other, thereby forming the transparent electrodes.

16. The method of manufacturing an electro-optical device according to claim 15,
the substrate including a silicon oxide film; and
when forming the optical thin film, stacking a silicon oxide nitride film on the substrate with a supply of oxygen gas, an amount of the supplied oxygen gas being controlled to decrease as a thickness of the stacked silicon oxide nitride film increases.

17. A method of manufacturing an electro-optical device in which a plurality of transparent electrodes is disposed above a substrate, the method comprising:
forming an optical thin film on the substrate so that the optical thin film and the substrate are adjacent to each other, a refractive index of the optical thin film being equal to a refractive index of the transparent electrodes, and an optical absorption coefficient of the optical thin film being smaller than an optical absorption coefficient of the transparent electrodes;
stacking an Indium Tin Oxide film on an upper side of the optical thin film so that the Indium Tin Oxide film and the optical thin film are adjacent to each other, thereby forming the transparent electrodes; and
controlling the thickness of the optical thin film and the transparent electrodes in a manner so that the thickness of the transparent electrodes combined with the thickness of the optical thin film being in a range of from about 120 to about 160 nm.

18. An electro-optical device, comprising:
a first substrate;
a second substrate opposing the first substrate;
a transparent electrode disposed between the first substrate and the second substrate; and
an optical thin film disposed between the transparent electrode and the first substrate, a refractive index of the optical thin film being greater than a refractive index of the first substrate and less than a refractive index of the transparent electrode.

19. The electro-optical device according to claim 18, a thickness of the optical thin film being in a range of from about 55 to about 100 nm.

20. The electro-optical device according to claim 18, the refractive index of the optical thin film gradually approaching the refractive index of the transparent electrodes as a vertical distance between the first substrate and the optical thin film increases.

21. A method of manufacturing an electro-optical device, the method comprising:
forming a first substrate with a first refractive index value;
forming an optical thin film above the substrate with a second refractive index value;
forming a transparent electrode above the optical thin film with a third refractive index value; and
the second refractive index value being between the first refractive index value and the second refractive index value.

22. A method of manufacturing an electro-optical device according to claim 21, the method further comprising controlling the thickness of the optical thin film to be in a range of from about 55 to about 100 nm.

23. A method of manufacturing an electro-optical device according to claim 22, wherein the thickness of the optical thin film is controlled by controlling at least one of a pressure, a temperature, or an amount of oxygen gas.

24. A method of manufacturing an electro-optical device according to claim 21, the method further comprising controlling the thickness of the optical thin film combined with the thickness of the pixel electrode to be in a range of from about 120 to about 160 nm.
